(19) United States
(12) Patent Application Publication
(10) Pub. No.: US 2026/0323124 A1
(43) Pub. Date: Oct. 15, 2026

(54) SYSTEMS AND TECHNIQUES FOR PROVIDING MEDIA CONTENT TO RECEIVERS

(71) Applicant: DISH Network L.L.C., Englewood, CO (US)

(72) Inventors: Lucky Vang, Englewood, CO (US); Alec Mcdaugale, Parker, CO (US); Simon Tang, Elizabeth, CO (US)

(21) Appl. No.: 19/179,242

(22) Filed: Apr. 15, 2025

(51) Int. Cl. H04N 21/472; H04L 9/40

(52) U.S. Cl. CPC H04N 21/472; H04L 63/08

(57) ABSTRACT

A method may include generating, by an application executed on the device, a request to configure the device according to a user account associated with a content provider. The method may include transmitting, by the application and to a computing system, at least some of the request to authenticate the user account associated with the content provider. The method may include receiving, by the application and from the computing system, configuration data associated with the user account, which in turn may include a plurality of profile settings.

The method may include generating, by the application, a temporary profile based at least in part on the configuration data, where the temporary profile may be configured to provide access to media content associated with the user account via a user interface. The method may include causing, by the application, the UI to be displayed according to the temporary profile.

### BACKGROUND

When users travel and stay in hospitality environments such as hotels and resorts, they often lose access to their personalized media environments. Hospitality establishments typically offer generic in-room entertainment systems with a limited selection of channels and content. These systems lack the ability to recognize individual user profiles, resulting in a one-size-fits-all experience that does not cater to the preferences of each guest. This disconnect can lead to decreased customer satisfaction, as guests are unable to enjoy the same level of personalization they have at home.

### BRIEF SUMMARY

A system of one or more computers may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions, that may include a method for providing media content to a device.

A method may include generating, by an application executed on the device, a request to configure the device according to a user account associated with a content provider. The method also may include transmitting, by the application executed on the device and to a computing system, at least some of the request associated with the content provider to authenticate the user account associated with the content provider. The method also may include receiving, by the application executed on the device and from the computing system, configuration data associated with the user account, which in turn may include a plurality of profile settings. The method also may include generating, by the application executed on the device, a temporary profile based at least in part on the configuration data, where the temporary profile may be configured to provide access to media content associated with the user account via a user interface (UI). The method may also include causing, by the application executed on the device, the UI to be displayed according to the temporary profile. Other embodiments of this aspect may include corresponding computer systems, apparatus, and computer programs recorded on one or more computer storage devices, each configured to perform the actions of the methods.

Implementations may include one or more of the following features. The method where the application may be associated with the content provider. The method where the application may communicate with an on-site backend to transmit the request to the computing system. The application may generate the request based on a trigger that may include at least one of a user input, a command from an on-site backend, or a signal from a user device. The command from the on-site backend may be associated with at least one of a Wi-Fi sign in or a user registration. The application may be configured to remove software or applications from a device. Implementations of the described techniques may include hardware, a method or process, or computer software on a computer-accessible medium.

One general aspect includes a system for providing media content to a device. The system also may include a device, which in turn may include: a processor; and a memory storing instructions that, when executed by the processor, may cause the device to: generate a request to configure the device according to a user account associated with a content provider; transmit at least a portion of the request to a computing system to authenticate the user account associated with the content provider; receive configuration data associated with the user account, the configuration data may include a plurality of profile settings; generate a temporary profile based at least in part on the configuration data, where the temporary profile may be configured to provide access to media content associated with the user account via a user interface (UI); and cause the UI to be displayed according to at least one of the temporary profile or the media content. Other embodiments of this aspect include corresponding computer systems, apparatus, and computer programs recorded on one or more computer storage devices, each configured to perform the actions of the methods.

Implementations may include one or more of the following features. The system further configured to: authenticate the user account associated with the content provider based on the request; and transmit to the device the configuration data associated with the user account. The computing system may be further configured to: transmit a reset command to the device to remove the association with the user account and to delete any profile settings and personalized media content associated with the user account from the device. The computing system may include an authentication server configured to authenticate user account credentials provided in the request. The device may be at least one of a television, a media player, or a set-top box. The computing system may be associated with the content provider. The computing system communicates with an on-. The device generates the request based on a trigger may include at least one of a user input, a command from an on-site backend, or a signal from a user device. The command from the on-site backend. Implementations of the described techniques may include hardware, a method or process, or computer software on a computer-accessible medium.

One general aspect includes. The system also includes a computing system may include one or more servers configured to: receive a request to configure a remote device according to a user account associated with a content provider; access one or more data stores storing configuration data associated with the user account, the configuration data may include: profile settings; a viewing history; a plurality of user preferences. The system also includes generate a temporary profile for the user account based at least in part on the configuration data, where the temporary profile may be configured to provide access to personalized media content on the remote device via a user interface (UI); transmit the temporary profile to the remote device to cause the device to display the UI according to the temporary profile; and transmit, upon occurrence of a termination event, a reset command to the remote device to remove the association with the user account and to delete any profile settings and personalized media content associated with the user account from the remote device. Other embodiments of this aspect include corresponding computer systems, apparatus, and computer programs recorded on one or more computer storage devices, each configured to perform the actions of the methods.

Implementations may include one or more of the following features. The system where the termination event may include at least one of: receiving a notification from a property management system indicating that the user has checked out of a hospitality location associated with the remote device; detecting a lack of user interaction with the remote device for a predetermined period of time; or receiving a user-initiated logout command from the remote device or a user device associated with the user account. The computing system may be further configured to: generate personalized media content recommendations based at least in part on the viewing history and user preferences; and include the personalized media content recommendations in the temporary profile transmitted to the remote device, where the remote device may be configured to display the personalized media content recommendations via the user interface. Implementations of the described techniques may include hardware, a method or process, or computer software on a computer-accessible medium.

### BRIEF DESCRIPTION OF THE DRAWINGS

FIG. 1 illustrates a system and a process for providing personalized media content to a media device in a hospitality environment, according to certain embodiments.

FIG. 2 illustrates a schematic diagram of a profile creation process within the system, according to certain embodiments.

FIG. 3 illustrates a process of updating and configuring a set-top box within a hospitality environment using an updated user profile, according to certain embodiments.

FIG. 4 illustrates a process flow diagram illustrating a method for configuring a media device in a hospitality environment to provide personalized media content to a user and subsequently removing user data upon the user's departure, according to some embodiments.

FIG. 5 illustrates an exemplary sequence diagram illustrating an example flow of data transmissions among the system components during the configuration and de-configuration of a media device in a hospitality environment, according to some embodiments.

FIG. 6 illustrates a flowchart illustrating a method for providing media content to a device within a hospitality environment, according to other embodiments.

FIG. 7 illustrates an example computing system, according to certain embodiments.

### DETAILED DESCRIPTION

In the following description, various embodiments of the invention are described with reference to the accompanying drawings. It is understood that the embodiments described are not limiting and that modifications may be made without departing from the scope of the invention.

The availability of media content to users has exploded in recent decades. Tracking, sorting, and suggesting media content may be a daunting task in just one location. However, when the same content needs to be accessible across multiple locations, such as when users travel, the complexity increases significantly. Users may expect their personalized media experiences to follow them wherever they go, including into hospitality environments like hotels, gyms, and resorts. This expectation may include access to personalized settings, preferred channels, viewing histories, and third-party applications they use at home. Meeting this demand may require systems that can dynamically synchronize user profiles with media devices located in diverse environments without compromising security or privacy.

The challenge may lie in creating a seamless transition of media services from the user's home environment to a hospitality setting. Traditional methods may often require manual input of credentials and preferences on unfamiliar devices, which may be inconvenient and raise security concerns. Additionally, hospitality venues may have varying levels of technological infrastructure, making integration with existing property management systems difficult. There is a need for a solution that can automatically configure in-room media devices according to individual user profiles, enabling users to enjoy their personalized media content while in certain embodiments, maintaining data security and compliance with content distribution regulations.

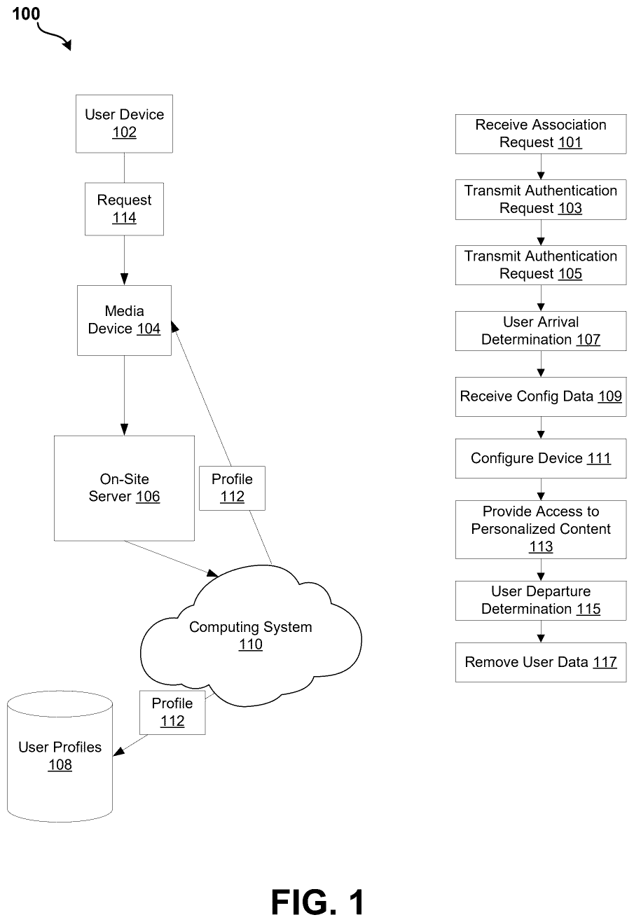

FIG. 1 illustrates a system 100 and a process 101 for providing personalized media content to a user, according to certain embodiments. The system 100 may be implemented in a multi-dwelling unit (MDU) environment. Examples of a Multiple Dwelling Unit (MDU) environment may include various residential and commercial settings where multiple individuals or groups occupy distinct spaces within a single property or complex. For instance, an apartment building or condominium complex may comprise numerous individual living units within one or more buildings. In such environments, each apartment or condo unit may include a set-top box (STB) or television configured to receive and display personalized media content tailored to the preferences of the occupant.

Other examples of MDU environments may include student housing facilities such as dormitories or university residential halls, where each student or group of students occupies a room or suite equipped with media devices capable of personalized content delivery. Senior living communities and assisted living facilities also may fall under this category, with residents having access to personalized media services in their individual rooms or common areas. Hospitality settings like hotels and resorts may be examples of MDU environments.

For example, a hotel may include several guest rooms. Each guest room may include a television receiver (e.g., an STB/TV) that may be configured to receive and display personalized media content. In another example, a gym may include television receivers (sometimes, “devices”) such as a video screen on or above a treadmill, elliptical machine or exercise bike.

These devices may be configured to provide personalized media content to users during their workouts, such as preferred music playlists, personalized training programs, or favorite television shows. Additionally, healthcare facilities like hospitals may equip patient rooms with media devices capable of personalized content delivery. Patients may receive entertainment, educational content, or important health information tailored to their needs. MDUs may be mobile. For example, cruise ships and other large passenger vessels may represent mobile MDU environments where guests occupy individual cabins equipped with media devices. Providing personalized media content in such settings can enhance the guest experience during their voyage. This system may facilitate the configuration of media devices to reflect the user's preferences and content subscriptions without manual input of credentials or preferences.

The system 100 may include several components that interact to deliver personalized media services. A user device 102 may include a personal computing device owned by the user, such as a smartphone, tablet, wearable device, laptop, or any other portable electronic device. This device may be used by the user to initiate the association of their content provider account with their upcoming stay at a hospitality venue. In some embodiments, the user device 102 may also include smartwatches, virtual reality headsets, or in-car infotainment systems that allow the user to manage their media preferences.

A media device 104 (e.g., a television receiver) may be located within the guest's room or any designated area within the hospitality venue and may include a set-top box, smart television, media player, streaming stick, or other devices capable of receiving and displaying media content. The media device 104 may also include integrated systems within the room's amenities, such as smart mirrors or interactive kiosks. In certain embodiments, the media device 104 may support voice commands, touch input, or gesture recognition to enhance user interaction.

The on-site server 106 may refer to the hospitality venue's backend systems, such as property management systems (PMS), customer relationship management systems (CRM), or other servers that manage guest check-ins, room assignments, billing, and additional services. The on-site server 106 may facilitate communication between the media device 104 and external systems, and may also manage network resources within the venue. In some embodiments, the on-site server 106 may be connected to IoT devices within the venue, enabling integration with room controls like lighting, climate, and security systems.

The user profiles 108 may be data repositories that store user account information, preferences, viewing history, application settings, and other personalization data. The user profiles 108 may be stored locally on the user's device, in a cloud-based storage system, or within the content provider's secure servers. The profiles may include preferences for content genres, language settings, accessibility options, and linked third-party services. In some embodiments, the user profiles 108 may be updated dynamically based on the user's interactions during their stay.

The computing system 110 may be a remote server or a group of servers managed by the content provider, handling authentication, profile management, content delivery, and communication among the user device, media device, and on-site server. The computing system 110 may additionally or alternatively include one or more virtual machines implemented on a cloud-based computing platform, distributed across multiple data centers for redundancy and scalability. The computing system 110 may employ secure communication protocols to protect user data and may interface with third-party content providers to aggregate media offerings. In certain embodiments, the computing system 110 may utilize machine learning algorithms to analyze user preferences and enhance content recommendations.

In various embodiments, the system 100 may support different deployment scenarios. For example, the user device 102 may initiate the association by scanning a QR code provided at check-in, or by connecting to the hospitality venue's Wi-Fi network, which may trigger the application to communicate with the content provider's computing system 110. The media device 104 may be configured to automatically detect the presence of the user device 102 via Bluetooth, NFC, or other proximity-based technologies, enabling efficient configuration.

The on-site server 106 may manage multiple media devices 104 across the venue, ensuring that each device is appropriately configured for the assigned user. The user profiles 108 may be synchronized across multiple devices, allowing the user to access their personalized content in different locations within the venue, such as in the gym, lounge areas, or conference rooms.

The content provider's computing system 110 may also integrate with external services for handling payment processing, digital rights management, or compliance with regional content regulations. Additionally, the system 100 may be designed to accommodate users without prior content provider accounts by providing options to create temporary guest profiles.

At step 103, the media device 104 may receive an association request from the user device 102. In operation, when a user makes a reservation at a hospitality venue, they may receive a reservation confirmation that includes a prompt to link their content provider account with their stay. This prompt may be presented in various formats, such as an email hyperlink, a text message with a link, a prompt within a mobile application, or a notification on a web portal. By interacting with this prompt on their user device 102, which may involve clicking a hyperlink, scanning a QR code, or utilizing an NFC tag and providing authentication information, the user may initiate an association request to the content provider's computing system 110. The authentication information may include login credentials, biometric verification, or a one-time passcode. This request may indicate the user's intent to synchronize their personal media profile with the media device 104 that will be available in their assigned room. In certain embodiments, this may be an assigned media device in a shared location (e.g. a treadmill in a gym).

In some embodiments, the user device 102 may automatically detect the opportunity to associate with the hospitality venue upon entering the premises or connecting to the venue's Wi-Fi network. The user may receive a push notification prompting them to link their account. Alternatively, the user may initiate the association through the venue's mobile app, which may integrate with the content provider's services. The system may support various authentication methods to accommodate different user preferences and security requirements.

Upon receiving the association request, the content provider's computing system 110 may authenticate the user account and prepare to configure a media device according to the user's preferences. The authentication process may involve verifying the user's credentials, which may be stored securely within the content provider's databases. Communication between the user device 102 and the content provider's computing system 110 may occur over secure networks, utilizing encryption protocols such as SSL/TLS to protect sensitive information like login credentials and personal data.

In some embodiments, the content provider's computing system 110 may perform additional security checks, such as evaluating the location of the user device 102, checking for unusual login activity, or requiring multi-factor authentication. The system may also handle cases where the user's account has restrictions or limitations, providing appropriate messages or alternative options.

As the user arrives at the hospitality venue and checks in, the on-site server 106 may detect the user's arrival and assign a specific room to the guest. This room assignment may include associating the guest with a particular media device 104, identified by its unique electronic serial number (ESN), receiver ID, MAC address, or other identifiers. The on-site server 106 may communicate with the content provider's computing system 110 to provide notification of the user's arrival and room assignment, allowing for the initiation of the device configuration process.

The detection of the user's arrival may be facilitated through various means, such as scanning a government-issued ID, swiping a loyalty card, or recognizing the user's mobile device via proximity sensors. The on-site server 106 may also handle group reservations, assigning multiple rooms or devices accordingly. Communication between the on-site server 106 and the content provider's computing system 110 may employ secure APIs or messaging protocols.

At step 105, the media device 104, upon recognizing that a new guest has checked into the room, may transmit an authentication request 114 to the content provider's computing system 110. This request may aim to verify the user's credentials and confirm permission to access personalized content on the media device. The authentication request 114 may include details such as the media device's identifier, the room number, the user's account information, and any session tokens. Alternatively, the on-site server 106 may facilitate this process by transmitting the authentication request 114 on behalf of the media device, based on check-in information available through the hospitality venue's systems. In this scenario, the on-site server 106 may act as an intermediary, aggregating requests from multiple media devices and managing communication efficiency. The system may accommodate situations where direct internet access from the media device 104 is restricted or controlled by the venue's network policies. In certain embodiments, the media device 104 may have embedded capabilities to authenticate with the content provider's computing system 110 automatically, without requiring intervention from the on-site server 106. This may be advantageous in venues that support self-service check-in or have minimal on-site infrastructure.

Following successful authentication, the content provider's computing system 110 accesses the user profiles 108 to retrieve configuration data (109) associated with the user's account. This configuration data may include personalization elements such as preferred channel lists, viewing history, application settings, and other user-specific preferences. The computing system 110 then transmits this configuration data to the media device 104 in the guest's room.

Following successful authentication, the content provider's computing system 110 may access the user profiles 108 to retrieve configuration data 109 associated with the user's account. This configuration data may include personalization elements such as preferred channel lists, viewing history, application settings, language preferences, accessibility options, and other user-specific preferences. The computing system 110 may then transmit this configuration data to the media device 104 in the guest's room.

The transmission of configuration data may be optimized for bandwidth considerations, possibly employing data compression or differential updates to minimize the amount of data transferred. The system may also factor in regional content restrictions or licensing agreements, adjusting the available content to comply with local regulations. In some embodiments, the content provider's computing system 110 may augment the user's profile with venue-specific offerings or promotions.

The media device 104 may proceed to configure itself 111 according to the received data. This configuration process may involve updating firmware, installing applications, setting up user preferences, and adjusting settings to align with the user's profile. For instance, if the user has third-party streaming applications like Netflix, Hulu, Disney+, or Amazon Prime Video on their home device, the media device 104 may install these applications and automatically log the user in, eliminating the need for manual credential entry.

The process may include setting up custom channel guides, arranging app icons according to the user's preferences, or configuring parental controls as per the user's settings. The media device 104 may also check for compatibility with the hotel's network and adjust streaming quality or buffering settings accordingly. In certain embodiments, the device may support integration with in-room controls, allowing the user to manage lighting, temperature, or other amenities through the media device interface.

Once configured, the media device 104 provides access to personalized content 113, offering the user an entertainment experience aligned with their preferences. The user interface may display a welcome message, show the user's favorite channels, and present content recommendations based on their viewing history. The user may access recordings, on-demand content, and other features that are part of their content provider account, in certain embodiments, subject to local content regulations and rights management considerations.

During the user's stay, the media device 104 and the content provider's computing system 110 may maintain bidirectional communication. This interaction may allow for updates to the user's profile based on their activity during the stay, ensuring that preferences are synchronized across devices. For example, if the user watches new content or adjusts certain settings, these updates may be reflected in their user profiles 108, maintaining consistency when they return home.

The system may handle network fluctuations or downtime by caching updates locally and synchronizing when connectivity is restored. Privacy considerations may be addressed by allowing the user to control what data is synchronized, providing options to disable certain tracking features if desired. In some embodiments, the content provider may use aggregated data to improve services or tailor content offerings.

Upon the user's departure, the system may ensure that personal data is securely removed from the media device 104 to protect the user's privacy. The on-site server 106 may detect the user's checkout 115, which may occur in hospitality settings through methods such as processing at the front desk, completion of an online checkout form, or automatic detection based on the reservation end date. The on-site server 106 may communicate the user's departure to the content provider's computing system 110, which may then send a command to the media device 104 to remove user data 117.

In some embodiments, the system may include a grace period to account for late checkouts or extended stays, adjusting the data removal schedule accordingly. The removal command may include instructions to the media device 104 to perform a secure wipe of user data. The system may also update the user's profile to reflect the end of the stay, possibly triggering follow-up communications like satisfaction surveys or special offers.

The media device 104 executes a data removal process, which may include logging out of user accounts, deleting cached data and temporary files, and resetting settings to default values. The media device 104 may perform self-diagnostics after the data removal to verify that all processes completed successfully. In some implementations, a confirmation message may be sent to the content provider's computing system 110 and the on-site server 106, indicating that the media device 104 is ready for the next user. The system may include safeguards to prevent reuse of the device until the data removal is confirmed, ensuring that no residual data persists.

The system described in FIG. 1 can accommodate various triggers for initiating the configuration and de-configuration processes. The initial configuration may be triggered by user input when the guest interacts with the media device upon entering the room. Alternatively, commands from the on-site backend systems can initiate the process based on check-in information. Signals from the user device 102, such as detection of the device on the hotel's Wi-Fi network, may also serve as triggers.

Integrating third-party applications into the personalized media experience may require additional considerations. Permissions and agreements with respective service providers may be in place to allow for auto-installation and automatic login functionalities. The system may handle these integrations while respecting the terms of service of each application and adhering to content distribution regulations, particularly concerning geographic content restrictions and rights management.

From a technical implementation standpoint, the content provider's computing system 110 can expose application programming interfaces (APIs) that facilitate communication and data exchange with the media device 104 and the on-site server 106. Authentication processes may employ secure methods such as OAuth or token-based authentication, providing robust security while minimizing user inconvenience. Data storage for user profiles can be managed with strict security measures, including encryption at rest and in transit, access controls, and regular security audits.

In practical usage scenarios, a user who may be a subscriber to the content provider can extend their personalized media environment to their hotel room. By linking their account prior to arrival, they can experience an entertainment setup that reflects their preferences without the need for manual configuration. This approach enhances user satisfaction and provides a competitive advantage for hospitality venues offering such services.

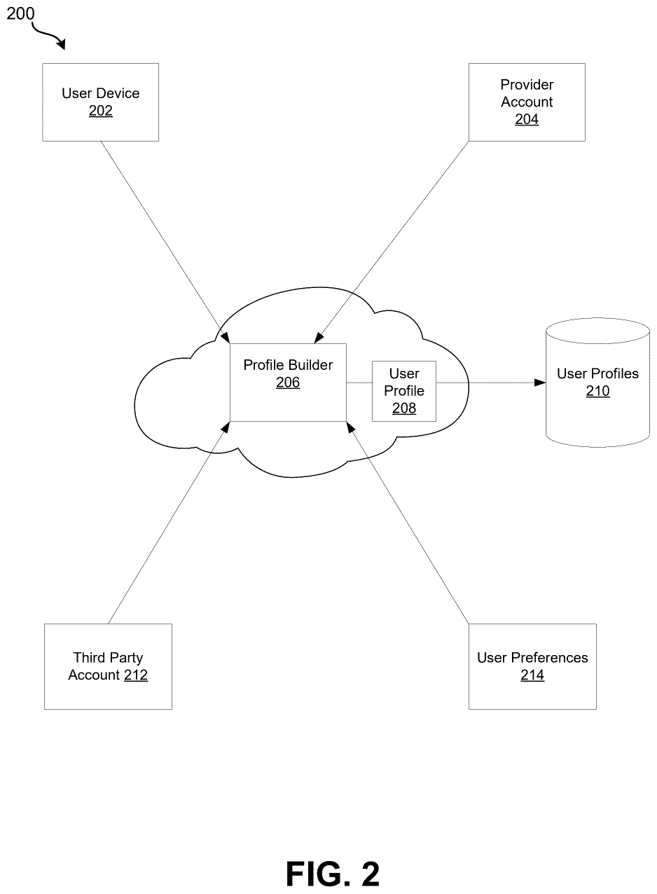

FIG. 2 illustrates a profile creation process within the system. This figure demonstrates how user data and preferences may be utilized to build a user profile that can be used to configure a media device. The process may involve collecting information from various sources and aggregating it to create a comprehensive profile that reflects the user's preferences and account settings.

In FIG. 2, the user device 202 may represent a personal computing device owned by the user, such as a smartphone, tablet, laptop, wearable device, or even a desktop computer. The user may interact with this device to manage content provider services, update preferences, and potentially initiate the association of their account with a hospitality stay. The user device 202 may run applications provided by the content provider or may access web portals to adjust settings. In some embodiments, the user device 202 may include voice-activated assistants or smart home devices that can interface with the content provider's services.

The provider account 204 may correspond to the user's account with the content provider, such as a satellite television service, cable provider, internet streaming service, or any media content supplier. This account may contain subscription details, service packages, authentication credentials, billing information, and viewing history. The user may access and manage this account via the user device 202, using applications or web interfaces provided by the content provider. In some cases, the provider account 204 may support multiple users within a household, each with their own sub-profiles and preferences.

The third-party account 212 may denote accounts the user holds with external service providers, such as streaming platforms (e.g., Netflix, Hulu, Amazon Prime Video), music services (e.g., Spotify, Apple Music), gaming services (e.g. Steam, XBOX live), or other media applications. These accounts may be linked to the provider account 204 to enhance the user's media experience by incorporating additional content sources. The linking process may involve secure authentication protocols, allowing the content provider to access necessary information while preserving the security of the third-party accounts. In some embodiments, the user may choose which third-party accounts to link, providing flexibility in their media experience.

The user preferences 214 may include settings and preferences specified by the user, such as preferred languages, parental control settings, favorite channels, preferred content genres, display preferences, notification settings, and other customization options. These preferences may be set or updated by the user through interactions with the user device 202, and may be influenced by the user's behavior and viewing habits. For example, the system may suggest content based on historical viewing data, and the user may accept or modify these suggestions. In some embodiments, the user preferences 214 may be shared across multiple devices, ensuring a consistent experience.

The profile builder 206 may operate as a component within the system, potentially part of the content provider's computing system 110 or as a separate cloud-based service. It may serve to aggregate and process data from various sources to create a comprehensive user profile 208. The profile builder 206 may collect information from the user device 202, provider account 204, third-party account 212, and user preferences 214, as indicated by arrows drawn from these components toward the profile builder. In some embodiments, the profile builder 206 may include machine learning algorithms to analyze user data and provide personalized recommendations or predictive configurations.

The user profile 208 may represent the compiled profile that incorporates the user's preferences, account information, and other relevant data. The user profile 208 may be used to configure media devices to align with the user's preferences and services. The user profile 208 may be stored within a database or storage system (e.g. user profiles 210). This storage may be centralized or distributed across multiple servers or cloud services. In some embodiments, the user profile 208 may include metadata, such as timestamps of the last update, version control information, or flags indicating special conditions like content restrictions.

In FIG. 2, the profile builder 206 and user profile 208 are depicted within a cloud symbol, and in some embodiments, they may operate within a cloud-based environment or the content provider's computing system. Arrows from the profile builder 206 and user profile 208 point to the user profiles 210, representing the storage of compiled profiles.

The user may interact with their provider account 204 via the user device 202 to manage subscriptions, update preferences, or link third-party accounts 212. The user preferences 214 may be also specified or updated through interactions with the user device 202. The profile builder 206 may aggregate data from these sources to construct or update the user profile 208.

The profile builder 206 may process the collected data to resolve any conflicts in settings, ensure compatibility with various media devices, and format the profile data appropriately. For example, if the user has linked a third-party streaming account, the profile builder 206 may include authentication tokens, API keys, or other necessary information within the user profile 208 to enable automatic login on the media device. The profile builder 206 may also adjust content recommendations based on combined data from multiple sources, providing a more personalized experience. In some embodiments, the profile builder 206 may handle data normalization, translation between different data formats, or encryption before storing the profile.

Once the user profile 208 is created or updated, it may be stored within the user profiles 210 storage system. This storage system manages profiles for multiple users, allowing the content provider's computing system 110 to retrieve profiles as needed. The storage system may implement access controls, ensuring that only authorized components can read or modify the profiles. In some embodiments, the storage may be distributed geographically to reduce latency and improve access times. Backup and archival processes may be employed to prevent data loss and support recovery in case of failures.

In the context of a hospitality environment, when the user checks into a hotel and the system recognizes their arrival (as described in FIG. 1), the media device in the user's room may request the user profile 208 from the user profiles 210 via the content provider's computing system. The media device can then configure itself according to the user profile, enabling access to personalized content and settings.

The profile creation process may be dynamic and may allow updates whenever the user changes their preferences or account information. For instance, if the user subscribes to a new service or modifies parental control settings, the profile builder 206 can incorporate these changes into the user profile 208. The updated profile may be then stored in the user profiles 210, ensuring that the latest preferences are applied when the user accesses services from different devices or locations.

Data security and privacy considerations may be addressed through the use of encryption and access controls during data transmission and storage. Sensitive information from the provider account 204 and third-party account 212 can be protected to prevent unauthorized access. The system may be designed to handle scalability, accommodating a large number of users and profiles. The profile builder 206 and user profiles 210 may be implemented using cloud-based technologies, allowing for distributed computing resources and flexible storage solutions. The system may comply with GDPR or CCPA, and may provide users with control over their data usage and sharing preferences. Audit logs and monitoring tools may be used to detect and respond to security incidents.

By utilizing the components and interactions depicted in FIG. 2, the system can manage user profiles effectively, enabling personalized media experiences across different devices and locations. This approach supports the configuration of media devices in hospitality environments (and other environments) to reflect individual user preferences without requiring manual input at the point of use. Additional considerations may include ensuring compatibility of the user profile with various types of media devices by processing and formatting the profile data appropriately. Integration with third-party accounts 212 may involve secure authentication protocols to maintain security while enabling access to additional services.

The user profiles 210 storage system may implement redundancy and backup mechanisms to ensure data integrity and availability. Regular synchronization between the profile builder 206 and user profiles 210 may be performed to keep the profiles up to date. For example, synchronization could occur hourly, daily, every 12 hours, or at intervals determined by user preferences or system policies. In scenarios where the user accesses media services from multiple locations or devices, the system coordinates profile updates to maintain consistency in the user's experience across different platforms. Conflict resolution strategies may be employed to handle simultaneous updates or discrepancies between sources. In scenarios where the user accesses media services from multiple locations or devices, the system may coordinate profile updates to maintain consistency across different platforms. For instance, if the user adds a new favorite channel on the media device 104 in their hotel room and adjusts parental control settings on their user device 202 at the same time, the profile builder 206 may detect these simultaneous updates.

To handle such situations, conflict resolution strategies may be employed by the system. The profile builder 206 may compare timestamps of the changes to determine which updates are the most recent. It may merge non-conflicting changes, incorporate both updates if possible, or prioritize one device's changes over the other based on predefined rules or user preferences. Alternatively, the system may prompt the user to resolve discrepancies manually, allowing them to select their preferred settings.

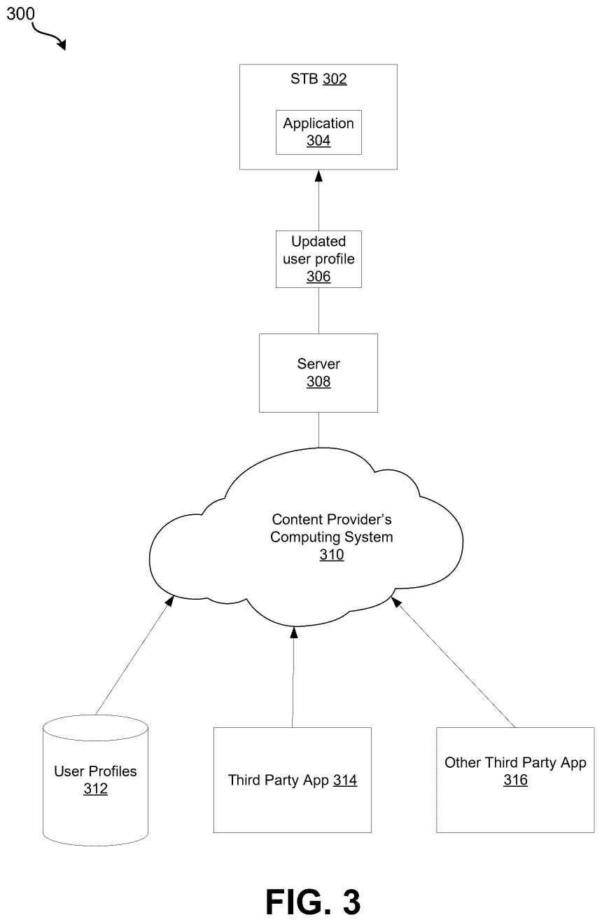

FIG. 3 illustrates the process of updating and configuring a set-top box within a hospitality environment using an updated user profile. In this figure, several components may interact to enable the set-top box to deliver personalized media content according to the user's preferences. The process may involve communication between the set-top box, servers, and various applications to ensure that the user's media experience is tailored to their preferences and subscriptions.

The set-top box (STB) 302 may represent the media device located in the user's room in an MDU. The set-top box 302 may receive configuration data and deliver media content based on the user's updated profile. The set-top box 302 can be a standalone device connected to the television or integrated within a smart TV system. In some embodiments, the set-top box 302 may support additional functionalities such as voice control, high-definition streaming, or integration with other in-room technologies like lighting and climate control.

Within the set-top box 302, a streaming media application (“application”) 304 may be implemented. The application 304 may be responsible for handling communication with external servers, processing configuration data, managing the user interface, and facilitating access to media content and third-party applications. The application 304 may be developed by the content provider or by third-party developers under agreement with the content provider. It may support various user interface themes, languages, and accessibility options to cater to different user needs.

The application 304, situated within the set-top box 302, may utilize the updated user profile 306 to configure the device according to the user's current preferences and subscriptions. This can involve installing or updating third-party apps like 314 and 316, adjusting settings such as preferred language, display resolution, or parental controls, and managing the user interface layout. For example, the application 304 may reorganize app icons based on the user's most frequently used services or apply a theme that aligns with the user's preferences.

The updated user profile 306 represents the user's profile that has been modified or enhanced, possibly during the user's stay or as a result of new preferences or subscriptions. The updates may include changes in viewing history, newly added favorite channels, or adjustments to settings like closed captioning preferences. The updated user profile 306 may be used by the set-top box 302 to adjust its configuration accordingly, ensuring that the media content and settings reflect the latest user preferences.

A server 308 may act as an intermediary between the set-top box 302 and the content provider's computing system 310. The server 308 may facilitate communication, authentication, and data transfer between the set-top box and external systems. In some embodiments, the server 308 may be part of the hospitality venue's network infrastructure, handling requests from multiple set-top boxes within the venue. The server 308 may manage bandwidth allocation, caching of content or configuration data, and may enforce venue-specific policies regarding network usage.

The computing system 310 may represent the backend infrastructure managed by the content provider. This system may handle user authentication, profile management, content delivery, and coordination with various content and application sources. The computing system 310 may include servers, databases, and services that collectively support the delivery of personalized media content to users in different locations.

The user profiles 312 can be a storage system or database where user profiles are maintained. This storage may include both initial profiles and any updated versions, allowing retrieval and synchronization as needed. The user profiles 312 may be implemented using secure databases with encryption and access controls to protect user data. In some embodiments, redundancy and distributed storage may be employed.

Third-party app 314 and other third-party app 316 represent external applications and services that the user may access through the set-top box 302. These could include streaming services like Netflix, Hulu, or Amazon Prime Video, music applications like Spotify or Pandora, or other media platforms such as YouTube, educational content providers, or gaming services. The inclusion of these apps may enhance the user's entertainment options.

Integration with these third-party apps may involve installing the applications on the set-top box 302 and handling user authentication. The system may support automatic login by utilizing credentials stored in the updated user profile 306, or may prompt the user to authenticate individually for each app. The availability of third-party apps may be subject to agreements between the content provider and the app developers, as well as regional content licensing restrictions.

After the user has interacted with media services, their profile may have been updated to reflect new preferences, viewing history, or added subscriptions. For instance, the user may have subscribed to a new streaming service, adjusted their preferred content genres, or rated content during their stay. The content provider's computing system 310 can aggregate these updates, possibly receiving information from user profiles 312 and activity data from third-party apps 314 and 316. The content provider's computing system 310 may process the collected data to update the user profile 306. Machine learning algorithms may be employed to analyze viewing patterns and suggest new content or adjust recommendations. The updated user profile 306 may include updated authentication tokens, newly added services, or modified settings.

The updated user profile 306 may then be transmitted to the set-top box 302. Server 308 can facilitate this transmission, handling any authentication or data formatting. Upon receiving the updated profile, the application 304 within the set-top box 302 may process the information to adjust configurations accordingly. This may involve installing new third-party apps, updating existing ones, adjusting user interface elements, or changing settings according to the user's latest preferences. For example, if the user subscribed to a new streaming service, the application 304 can install the corresponding app (e.g., third-party app 314), log the user in using credentials from the updated profile, and add the app to the main menu for easy access.

In the example, where the user subscribed to a new streaming service during their stay, the updated user profile 306 may include credentials or permissions related to that service. The application 304 can then install or enable the corresponding third-party app 314 on the set-top box 302, allowing the user to access the new content. The set-top box 302 and the application 304 may also send data back to the content provider's computing system 310, such as usage statistics or further updates to the user's profile. This bidirectional communication allows for continuous synchronization between the user's activities on the set-top box and their overall profile.

Upon the user's departure from the hospitality venue, the set-top box 302 may receive a command to remove the user's data, including any installed third-party apps like 314 and 316, as well as cached information or credentials. This ensures that personal data may be not retained on the device. The system illustrated in FIG. 3 may be designed to handle scalability, supporting numerous users and devices across many various locations. Cloud-based infrastructure for the content provider's computing system 310 and user profiles 312 can facilitate this scalability.

Integration with third-party apps 314 and 316 may require coordination with external service providers. In certain embodiments, the system can manage authentication tokens and permissions in compliance with the policies of these providers. This may involve implementing secure authentication protocols like OAuth or OpenID Connect to handle user logins without exposing sensitive credentials.

The content provider's computing system 310 may need to maintain updated agreements with third-party providers to ensure that content licensing, regional restrictions, and usage policies are adhered to. The system may also need to handle updates to third-party apps, ensuring that the latest versions are available on the set-top box 302 and that any changes in app functionality or policy are managed appropriately.

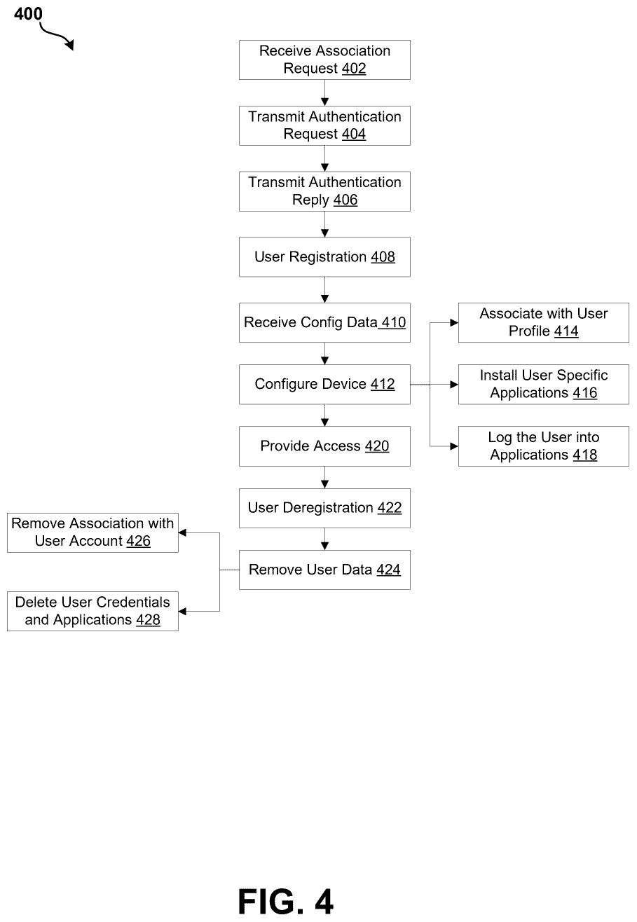

FIG. 4 illustrates a process flow diagram 400 for configuring a media device to provide personalized media content to a user, according to certain embodiments. At step 402, the system may receive an association request. This request can be initiated by the user through their user device when they link their content provider account with their upcoming stay at the hospitality venue, or select a device in an MDU. In certain embodiments, this can be done by checking into a hotel room, signing onto the hotel or gym's Wi-Fi network, or by an app on a mobile device. The association request allows the system to recognize the user's intent to access personalized media services during their visit. The association request at step 402 may also be initiated through a wearable device, such as a smartwatch, by tapping it against a compatible reader in the room. The system may use technologies like NFC or Bluetooth for such interactions.

Following the association request, at step 404, the system can transmit an authentication request. This authentication request may be sent from the media device in the user's room or through the hotel's on-site server to the content provider's computing system. The purpose of this request may be to verify the user's credentials and ensure that they have the permissions to access personalized content. At step 404, authentication may involve multi-factor authentication methods, including biometric verification like fingerprint or facial recognition via the user device. The content provider's computing system may support these methods to enhance security. Upon processing the authentication request, the content provider's computing system may send an authentication reply at step 406. This reply can indicate whether the authentication was successful and may include additional information required for subsequent steps. If authentication was unsuccessful the process can be terminated or in certain embodiments, retried. The system may notify the user of the failure and provide options to re-enter credentials or seek assistance.

If authentication is successful, the process may continue to user registration at step 408. User registration may involve associating the user's account with the specific media device in their assigned room. This association can be facilitated by using identifiers such as the electronic serial number (ESN) or receiver ID of the media device. At step 410, the media device may receive configuration data from the content provider's computing system. This configuration data can include the user's preferences, account settings, and any other information to personalize the media device according to the user's profile.

The media device proceeds to configure itself at step 412 based on the received configuration data. At this point, several subprocesses may occur as part of the configuration: At step 414, the media device may associate with the user profile. This involves applying the user's preferences and settings to the device, ensuring that the user interface and available content align with their expectations. At step 416, the device can install user-specific applications. This may include downloading and installing third-party apps that the user has linked to their account, such as streaming services or specialized media applications. At step 418, the device may log the user into applications automatically. Using credentials provided in the configuration data, the media device can sign the user into installed applications, eliminating the need for manual credential entry. During configuration at step 412, the media device may also synchronize with other in-room devices, such as smart speakers or IoT devices, to provide a unified smart room experience. This may include adjusting lighting, temperature, or other environmental settings according to the user's preferences.

After configuration, the process moves to step 420, where the media device provides access to personalized media content. The user can now interact with the device as they would with their home media setup, accessing preferred channels, applications, and personalized content recommendations. When the user's stay concludes, the system may detect user deregistration at step 422. This may occur when the user checks out of the hotel, either through interaction with the front desk, a kiosk, or directly via the media device if such functionality is available. In some embodiments, the deregistration involves a timeout period after which the system automatically initiates deregistration if no activity is detected. In scenarios where the user initiates the deregistration manually, the media device may provide an option to “Clear Personal Data” or “Log Out” accessible through the device's settings menu.

Following deregistration, the system initiates removal of user data at step 424 to ensure privacy and security. At this step, the process flow branches into subprocesses that handle the cleanup of the media device: At step 426, the device may remove the association with the user account. This disassociation ensures that the device is no longer linked to the user's profile and prevents access to their personalized settings. At step 428, the device can delete user credentials and applications. This can involve removing any stored login information and uninstalling user-specific applications that were installed during the configuration process. This step helps to prevent unauthorized access to the user's accounts and maintains the integrity of the device for subsequent guests. By executing these subprocesses, the media device returns to a default state, ready to be configured for the next guest without retaining any residual data from the previous user. Error handling procedures can be incorporated to manage situations where configuration data cannot be retrieved or applied fully. In such cases, the media device may offer limited functionality or default settings while awaiting successful configuration. Error handling at the end may include fallback options where the media device provides access to basic channels or guest accounts with limited functionality. The device may display informative error messages guiding the user through troubleshooting steps.

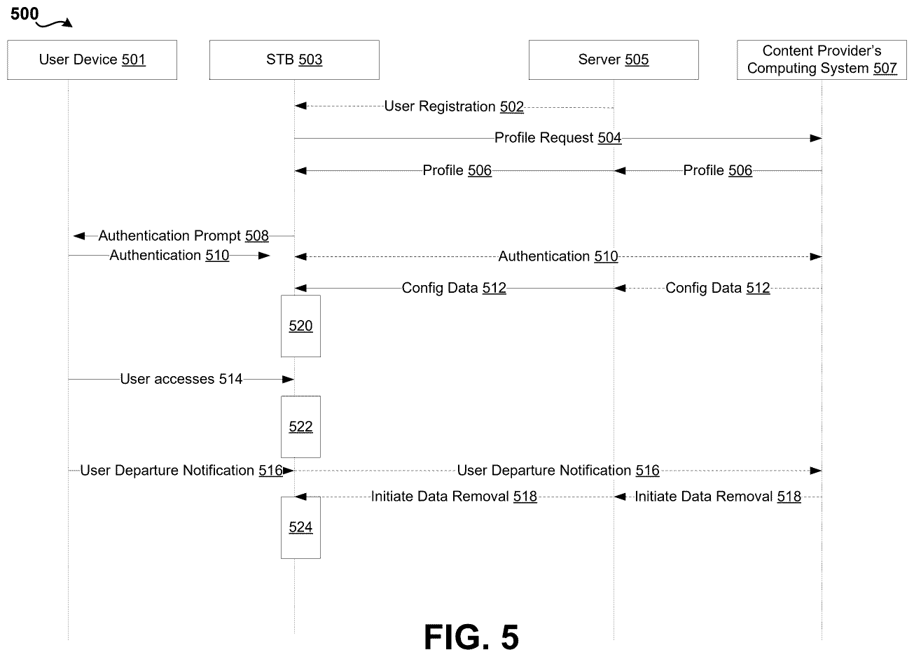

Referring now to FIG. 5, a sequence diagram illustrates an example flow of data transmissions among the system components during the configuration and de-configuration of a media device in a hospitality environment. The components involved include the user device 501, the set-top box (STB) 503, the server 505, and the content provider's computing system 507. This diagram demonstrates how these components may interact to provide personalized media content to the user and subsequently remove user data upon departure. The communications among these components can occur through various transmission media, including Wi-Fi networks, wired Ethernet connections, cellular data networks, or the public Internet. The specific media used may depend on the infrastructure of the MDU, the capabilities of the devices, and user preferences.

The sequence can begin with user registration 502, represented by a dashed line from the server 505 to the STB 503. This indicates that the server may initiate a registration process with the STB, preparing it to associate with the incoming user's account. The STB 503 then sends a profile request 504 to the content provider's computing system 507. This is depicted as a solid line from the STB to the computing system, indicating a direct communication where the STB requests the user's profile information for configuration. The communication between the server 505 and the STB 503 may occur over the hotel's local area network (LAN), which can utilize wired Ethernet connections or Wi-Fi networks within the building. The server 505 may send registration commands or configuration data to the STB 503 over this network.

In response, the profile 506 data may be transmitted from the content provider's computing system 507 to the STB 503, passing through the server 505. This transmission can travel through the hotel's network infrastructure to reach the Internet and subsequently the content provider's computing system 507, which may be hosted on cloud servers or at remote data centers. The STB 503 may connect to the Internet via the hotel's broadband connection, which might include fiber-optic cables, DSL lines, or satellite links, depending on the venue's setup. Secure protocols like HTTPS may be used to protect the data during transit.

The STB 503 may then issue an authentication prompt 508 to the user device 501, as represented by a line from the STB to the user device. This prompts the user to provide authentication credentials or confirm their identity, enabling secure access to personalized content. The user device 501 responds with an authentication 510 message back to the STB 503, completing the authentication process and allowing the STB to proceed with configuration. The data may travel over the public Internet to reach the hotel's network, entering through the broadband connection. Within the hotel's network, the server 505 may receive the data and forward it to the STB 503 over the LAN. This intermediate step can provide additional security, allowing the server 505 to validate incoming data before it reaches the STB. Secure communication protocols like SSL/TLS may be employed to ensure the integrity and confidentiality of the data. The communication between the STB 503 and the user device 501 may occur over the hotel's Wi-Fi network, allowing devices connected to the same network to communicate. Alternatively, Bluetooth or NFC technology may be used if the devices are in close proximity. For example, the STB 503 may display a QR code on the connected television screen, which the user scans using their smartphone (e.g. user device 501) to initiate authentication.

Following successful authentication, configuration data 512 may be sent from the content provider's computing system 507 to the STB 503, possibly via the server 505. This data includes information needed to personalize the STB according to the user's preferences and account settings. The STB 503 enters a setup process 520, represented by a box on the STB's timeline. During this process, the STB configures itself based on the received configuration data, installs applications, and logs the user into relevant services. The use of content delivery networks (CDNs) by the content provider may optimize the data transfer by reducing latency and improving download speeds.

Once the setup is complete, the user engages with the system, depicted by user accesses 514, a line from the user device 501 to the STB 503. This represents some embodiments where the user device can be operated as a remote control or any other of the user's interaction with the media device to access personalized content and services.

The period during which the user consumes media content is indicated by a consumption process 522, shown as a box on the STB's timeline. This may encompass the user's entertainment experience during their stay, where they may enjoy personalized channels, applications, and content. The STB 503 may stream content from the content provider's computing system 507 over the Internet, using adaptive bitrate streaming to adjust to the available network bandwidth. The data may traverse multiple networks, including the hotel's internal network, the ISP's network, and the content provider's distribution networks. Streaming protocols like HLS or DASH may be used to deliver the media content efficiently.

Upon the user's departure, a user departure notification 516 may be sent. This notification originates from the user device 501 to the STB 503, then continues as a dashed line to the server 505 and as a solid line to the content provider's computing system 507. This sequence suggests that the system becomes aware of the user's checkout, initiating the data removal process. The “user departure notification 516” may also typically originate from the server 505 (e.g., the hotel's property management system) rather than the user device 501, as in certain embodiments, it may be the hotel's system that detects checkout events.

The content provider's computing system 507 then initiates data removal 518, sending a command to the STB 503 via the server 505. This instructs the STB to delete user data, credentials, and personalized settings, returning the device to a default state. The STB 503 performs the cleanup process 524, represented by a box on its timeline. During this process, the STB may remove user-specific data and prepare for the next guest, and in certain embodiments, different measures may be taken to ensure that no personal information remains accessible. This may involve uninstalling applications, clearing caches, and resetting configurations. The STB may also perform a security audit to confirm that all personal data has been effectively erased. Upon completion, the STB may send a confirmation message back to the server 505 or the content provider's computing system 507, acknowledging that it is ready for the next user. The STB may verify the authenticity of the command, potentially using digital signatures or secure tokens, before proceeding with data removal. The communication channels used may include wired Ethernet connections within the hotel or Wi-Fi networks, depending on the network design. In some embodiments, this last step may be skipped entirely.

It should be noted that this is just an example flow of data transmissions, and variations may exist depending on the specific implementation and system architecture. The sequence and origin of certain messages may differ based on system design choices. In some embodiments, certain steps may be skipped, reordered, or done differently.

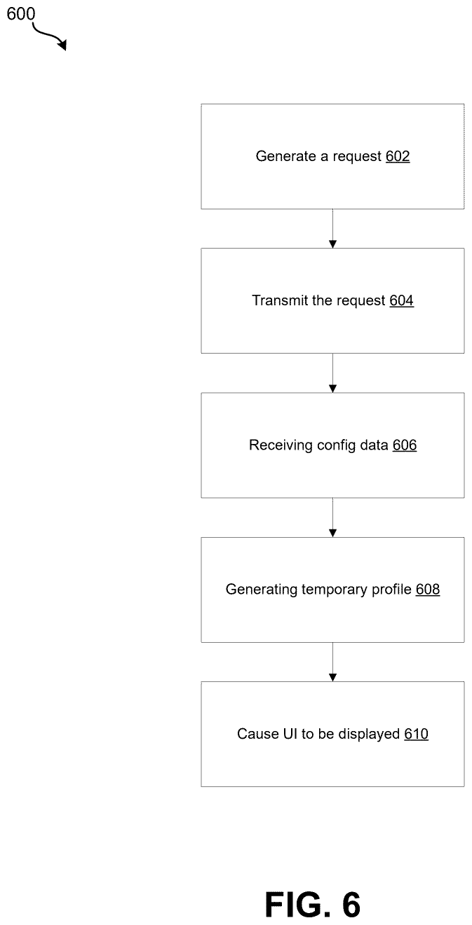

Referring now to FIG. 6, a flowchart illustrates a method for providing media content to a device within a hospitality environment. This method enables the device to be configured according to a user account associated with a content provider, allowing the user to access personalized media content during their stay. The steps in the flowchart ensure that the processes are carried out by an application executed on the device.

At step 602, the application executed on the device may generate a request to configure the device according to a user account associated with a content provider. This request can be initiated based on various triggers, such as user input, a command from an on-site backend system, or a signal from a user device. For example, the user may select an option on the device's menu, scan a QR code displayed on the device, or use a companion app on their smartphone to initiate the request. The request may signify the intention to authenticate the user account and retrieve configuration data necessary for personalization.

In different embodiments, the application may detect the user's presence through proximity sensors, motion detectors, or by recognizing the user's device connecting to the local Wi-Fi network (e.g., a Wi-Fi sign-in). The request generation can also be triggered automatically upon device startup or when the device detects a change in occupancy status provided by the MDU's management system.

At step 604, the application may transmit the request to a computing system associated with the content provider. This transmission may involve sending at least a portion of the request to authenticate the user account. The communication between the application and the computing system can occur over a network, utilizing secure communication protocols to protect user credentials and data integrity.

At step 606, the application may receive configuration data associated with the user account from the computing system. The configuration data can comprise a plurality of profile settings, including user preferences, viewing history, installed applications, and other personalization information relevant to the media content and user interface.

At step 608, the application may generate a temporary profile based at least in part on the received configuration data. The temporary profile can be configured to provide access to media content associated with the user account via the user interface of the device. This temporary profile may include settings and credentials to personalize the media experience on the device during the user's stay.

The temporary profile may be stored in the device's volatile memory or a secure storage area to prevent unauthorized access. In some embodiments, the temporary profile may be encrypted and may include expiration parameters that automatically invalidate the profile after a certain period or upon a specific event like checkout.

At step 610, the application may cause the user interface to be displayed according to the temporary profile. This may involve adjusting the user interface to reflect the user's preferences, such as layout, themes, and access to personalized content and applications. The user can then interact with the device through the customized interface, accessing media content as if they were using their home device. For example, the device may display a personalized welcome message, organize apps and channels based on the user's favorites, and recommend content aligned with the user's viewing history (e.g., a user history). The interface may support multiple languages, and accessibility features like screen readers or high-contrast modes may be enabled according to the user's settings.

The method illustrated in FIG. 6 allows the device to be dynamically configured to align with the user's preferences and account settings associated with the content provider. By executing these steps, the system enables the user to enjoy a personalized media experience without the need for manual input of credentials or configuration settings upon arrival at the MDU (e.g. a hospitality venue).

In some embodiments, additional functionalities may be incorporated into the method: The application may be configured to remove the temporary profile after a predetermined period of time or upon receiving a logout command or termination event, such as the user checking out of the hotel. This may ensure that user data does not persist on the device beyond the user's stay, maintaining privacy and security. The application may communicate with an on-site backend system to receive triggers or commands related to user check-in or check-out events. This communication can facilitate timely configuration and de-configuration of the device in synchronization with the user's status at the hospitality venue. The application may manage secure authentication processes, employing methods such as token-based authentication or encryption techniques to protect user credentials during transmission and storage. The device in this context may be any media-capable device located within the hospitality environment, such as a set-top box, media player, or smart television. The application executed on the device performs the steps to provide personalized media content to the user.

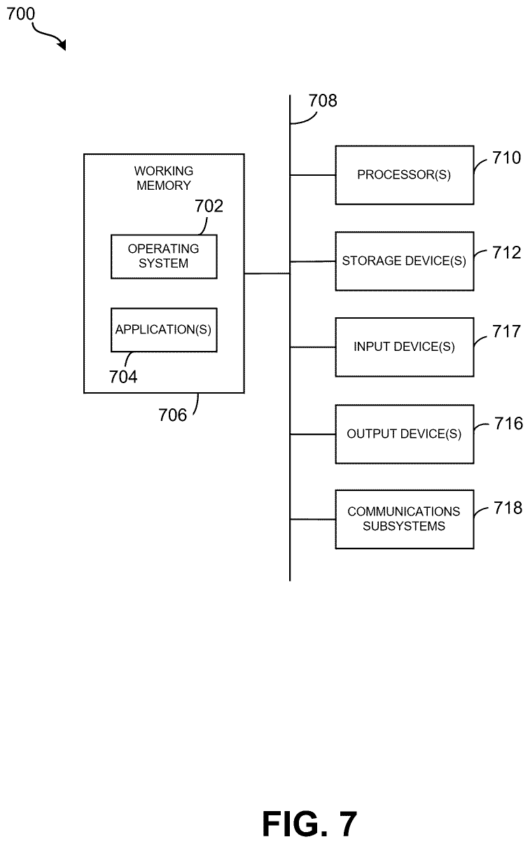

FIG. 7 illustrates an example computing system, according to certain embodiments. The computing system 700 is a simplified computing system that can be used to implement various embodiments described and illustrated herein and may be similar to those previously discussed. A computing system 700 as illustrated in FIG. 4 may be incorporated into devices, including any of the devices previously discussed. FIG. 4 provides a schematic illustration of one embodiment of a computing system 700 that can perform some or all of the steps of the methods and workflows provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computing system 700 is shown including hardware elements that can be electrically coupled via a bus 708, or may otherwise be in communication, as appropriate. The hardware elements may include one or more processors 710, including without limitation one or more general-purpose processors and/or one or more special-purpose processors such as digital signal processing chips, graphics acceleration processors, and/or the like; one or more input devices 714, which can include any of the devices previously discussed, such as a camera or media server; and one or more output devices 716, which can include any of the devices previously discussed, such as a television.

The computing system 700 may further include and/or be in communication with one or more non-transitory storage devices 712, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computing system 700 might also include a communications subsystem 718, which can include without limitation a modem, a network card (wireless or wired), an infrared communication device, a wireless communication device, and/or a chipset such as a Bluetooth™ device, a 802.11 device, a Wi-Fi device, a Wi-Max device, cellular communication facilities, etc., and/or the like. The communications subsystem 718 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 718. In other embodiments, a portable electronic device, e.g., the first electronic device, may be incorporated into the computer system 400, e.g., an electronic device as an input device 714. In some embodiments, the computing system 700 will further include a working memory 706, which can include a RAM or ROM device, as described above.

The computing system 700 also can include software elements, shown as being currently located within the working memory 706, including an operating system 702, device drivers, executable libraries, and/or other code, such as one or more application programs 704, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 4, might be implemented as code and/or instructions executable by a computer and/or a processor within a computer; in an aspect, then, such code and/or instructions can be used to configure and/or adapt a general-purpose computer or other device to perform one or more operations in accordance with the described methods.

A set of these instructions and/or code may be stored on a non-transitory computer-readable storage medium, such as the storage device(s) 712 described above. In some cases, the storage medium might be incorporated within a computer system, such as computer system 400. In other embodiments, the storage medium might be separate from a computer system, e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computing system 700 and/or might take the form of source and/or installable code, which, upon compilation and/or installation on the computing system 700, e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computing system 700 to perform methods in accordance with various embodiments of the technology. According to a set of embodiments, some or all of the operations of such methods are performed by the computing system 700 in response to processor 710 executing one or more sequences of one or more instructions, which might be incorporated into the operating system 702 and/or other code, such as an application program 704, contained in the working memory 706. Such instructions may be read into the working memory 706 from another computer-readable medium, such as one or more of the storage device(s) 712. Merely by way of example, execution of the sequences of instructions contained in the working memory 706 might cause the processor(s) 710 to perform one or more procedures of the methods described herein. Additionally, or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 712. Volatile media include, without limitation, dynamic memory, such as the working memory 706.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400.

The communications subsystem 718 and/or components thereof generally will receive signals, and the bus 708 then might carry the signals and/or the data, instructions, etc. carried by the signals to the working memory 706, from which the processor(s) 710 retrieves and executes the instructions. The instructions received by the working memory 706 may optionally be stored on a non-transitory storage device 712 either before or after execution by the processor(s) 710.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks. For example, executing instructions stored in the non-transitory computer-readable medium causes the processors to perform steps of methods and/or to implement features of components described herein.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

1. A method for providing media content to a television receiver, the method comprising:
generating, by a streaming media application executed on the television receiver, a request to configure the television receiver according to a user account associated with a content provider;
transmitting, by the streaming media application executed on the television receiver and to a computing system, at least some of the request associated with the content provider to authenticate the user account associated with the content provider;
receiving, by the streaming media application executed on the television receiver and from the computing system, configuration data associated with the user account comprising a plurality of profile settings comprising credentials for at least one third-party application linked to the user account;
generating, by the streaming media application executed on the television receiver, a temporary profile based at least in part on the configuration data, wherein the temporary profile is configured to provide access to media content associated with the user account via a user interface (UI); and
causing, by the streaming media application executed on the television receiver, the UI to be displayed according to the temporary profile.

2. The method of claim 1, wherein the streaming media application is associated with the content provider.

3. The method of claim 1, wherein the streaming media application communicates with an on-site backend to transmit the request to the computing system.

4. The method of claim 1, wherein the streaming media application generates the request based on a trigger comprising at least one of a user input, a command from an on-site backend, or a signal from a user device.

5. The method of claim 4, wherein the command from the on-site backend is associated with at least one of a Wi-Fi sign in or a user registration.

6. The method of claim 1, further comprising:
receiving, from the computing system, a reset command to the streaming media application to remove the association with the user account and to delete any profile settings and personalized media content associated with the user account from the television receiver.

7. The method of claim 1, wherein the configuration data includes media content recommendations based at least in part on a user history.

8. The method of claim 1, wherein the streaming media application is configured to remove the temporary profile after a predetermined period of time and/or upon receiving a logout command.

9. A television receiver for displaying media content, comprising:
one or more processors; and
a computer readable memory storing instructions that, when executed by the one or more processors, cause the television receiver to:
generate a request to configure the television receiver according to a user account associated with a content provider;
transmit at least a portion of the request to a computing system to authenticate the user account associated with the content provider;
receive configuration data associated with the user account, the configuration data comprising a plurality of profile settings comprising credentials for at least one third-party application linked to the user account;
generate a temporary profile based at least in part on the configuration data, wherein the temporary profile is configured to provide access to media content associated with the user account via a user interface (UI); and
cause the UI to be displayed according to at least one of the temporary profile or the media content.

10. The television receiver of claim 9, further configured to:
authenticate the user account associated with the content provider based on the request; and
transmit, to the television receiver, the configuration data associated with the user account.

11. The television receiver of claim 9, wherein the computing system is associated with the content provider.

12. The television receiver of claim 9, wherein the computing system communicates with an on-site backend to transmit the request to the computing system.

13. The television receiver of claim 9, wherein the television receiver generates the request based on a trigger comprising at least one of a user input, a command from an on-site backend, or a signal from a user device.

14. The television receiver of claim 13, wherein the command from the on-site backend is associated with at least one of a WiFi sign-in or a user registration.

15. The television receiver of claim 9, wherein the computing system is further configured to:
transmit a reset command to the television receiver to remove the association with the user account and to delete any profile settings and personalized media content associated with the user account from the television receiver.

16. The television receiver of claim 9, wherein the computing system comprises an authentication server configured to authenticate user account credentials provided in the request.

17. The television receiver of claim 9, wherein the television receiver is at least one of a television, a media player, or a set-top box.

18. A system comprising:
one or more processors; and
a computer readable memory storing instructions that, when executed by the one or more processors, cause the system to:
receive a request to configure a television receiver according to a user account associated with a content provider;
access one or more data stores storing configuration data associated with the user account, the configuration data comprising:
profile settings;
a viewing history;
a plurality of user preferences; and
credentials for at least one third-party application linked to the user account
generate a temporary profile for the user account based at least in part on the configuration data, wherein the temporary profile is configured to provide access to personalized media content on the television receiver via a user interface (UI);
transmit the temporary profile to the television receiver to cause the television receiver to display the UI according to the temporary profile; and
transmit, upon occurrence of a termination event, a reset command to the television receiver to remove the association with the user account and to delete any profile settings and personalized media content associated with the user account from the television receiver.

19. The system of claim 18, wherein the termination event comprises at least one of:
receiving a notification from a property management system indicating that a user associated with the user account has checked out of a hospitality location associated with the television receiver, detecting a lack of user interaction with the television receiver for a predetermined period of time, receiving a user-initiated logout command from the television receiver.

20. The system of claim 18, wherein the system is further configured to:
generate personalized media content recommendations based at least in part on the viewing history and user preferences; and
include the personalized media content recommendations in the temporary profile transmitted to the television receiver, wherein the television receiver is configured to display the personalized media content recommendations via the user interface.
